(19) United States
(12) Patent Application Publication
(10) Pub. No.: US 2025/0110067 A1
(43) Pub. Date: Apr. 3, 2025

(54) ITEM INSPECTION SYSTEMS AND METHODS

(71) Applicant: Smiths Detection France S.A.S., Vitry Sur Seine (FR)

(72) Inventors: Jean-Michel FAUGIER, Vitry-sur-Seine (FR); Thibaut BERTHELIER, Vitry-sur-Seine (FR)

(21) Appl. No.: 18/832,287

(22) PCT Filed: Jan. 11, 2023
(86) PCT No.: PCT/EP2023/050524

§ 371 Date: Jul. 23, 2024

(30) Foreign Application Priority Data
Jan. 25, 2022 (GB) 2200942.7

(51) Int. Cl. G01N 23/10; G01N 23/04; G01N 23/083

(52) U.S. Cl. CPC G01N 23/10; G01N 23/04; G01N 23/083; G01N 2223/401

(57) ABSTRACT

In some aspects, it is described an item inspection system for detecting the presence of one or more articles of interest in an item, the inspection system including an x-ray source configured to selectively direct x-ray radiation towards said item, a detection system including an active detection element arranged to detect x-ray radiation from the x-ray source after irradiation of the item, and a control assembly configured to control operation of the x-ray source to selectively direct x-ray radiation towards the item according to a timing schedule, wherein the control assembly includes a synchronisation interface configured to obtain an indication of a reference time based on a universal clocking signal, and wherein the control assembly is configured to select the timing schedule based on the reference time.

### CROSS-REFERENCE TO RELATED APPLICATIONS

This application is a national stage application of PCT/EP2023/050524, filed on Jan. 11, 2023, which claims priority to GB Application 2200942.7, filed on Jan. 25, 2022, both of which are incorporated herein by reference in their entirety.

### TECHNICAL FIELD

The present disclosure relates to the field of item inspection systems and methods. In particular, the present disclosure relates to the use of x-rays for inspecting items to identify the presence of one or more articles of interest in such an item.

### BACKGROUND

Item inspection systems may be provided for a number of different possible uses. For instance, item inspection systems can be used to scan shipping containers to try to identify the presence of any articles of interest contained within such shipping containers. In particular, item inspection systems may be used at customs and/or border facilities for inspecting containers entering into that country. Physically opening up and inspecting each shipping container would require vast amounts of time and manpower, and so would be too inefficient to practically implement. Also, where shipping containers are fully loaded with cargo, it may be difficult to access and view all the different regions of the shipping container. For these reasons, imaging technologies may be used to obtain images of the inside of shipping containers from outside the container. For this, X-ray and gamma ray scanners can be used to produce an image of the inside of the container for the purpose of identifying if there is likely to be material of interest within that container.

The present disclosure provides improved systems and methods for such an item inspection system.

### SUMMARY

Aspects of the disclosure are set out in the independent claims and optional features are set out in the dependent claims. Aspects of the disclosure may be provided in conjunction with each other, and features of one aspect may be applied to other aspects.

In an aspect, there is provided an item inspection system for detecting the presence of one or more articles of interest in an item. The inspection system includes an x-ray source configured to selectively direct x-ray radiation towards said item; a detection system including an active detection element arranged to detect x-ray radiation from the x-ray source after irradiation of the item; and a control assembly configured to control operation of the x-ray source to selectively direct x-ray radiation towards the item according to a timing schedule. The control assembly includes a synchronisation interface configured to obtain an indication of a reference time based on a universal clocking signal. The control assembly is configured to select the timing schedule based on the reference time.

The timing schedule may specify a sequence of operation timings to define a series of active and inactive periods for the x-ray source. The x-ray source may be controlled to direct x-ray radiation towards said item during the active periods, but not during the inactive periods. The control assembly may be configured to synchronise the operation timings for active and/or inactive periods with respect to the reference time obtained by the synchronisation interface. The timing schedule may align the operation timings for the active and inactive periods with the reference time so that the sequence of operation timings has a fixed temporal offset relative to the reference time. For example, the timing schedule may be selected to provide this alignment of the active and inactive periods. The sequence of operation timings which define the series of active and inactive time periods may follow a temporally repeating pattern, optionally wherein the timing schedule is selected based on the reference time so that the temporally repeating pattern for the operation timings has a fixed phase offset relative to the reference time.

The synchronisation interface may be configured to wirelessly receive and/or transmit universal clocking signals. The synchronisation interface may include a GPS module configured to wirelessly receive GPS signals. The universal clocking signal may include a GPS signal. The item inspection system may include a second detection element. The control assembly may be configured to control operation of the second detection element according to a second timing schedule. The second timing schedule may be selected based on the reference time. The second timing schedule may be temporally interleaved with the first timing schedule so that the second detection element is arranged to obtain second detection data for the item while the x-ray source is inactive. The second detection element may be arranged to detect other forms of radiation coming from said item. The second detection element may be configured to detect gamma radiation and/or neutrons.

The control assembly may be configured to control operation of the item inspection system to provide blanking of the second detection element when the x-ray source is directing x-ray radiation towards said item. Providing blanking of the second detection element may include at least one of: de-activating a detection output from the second detection element while the x-ray source is directing x-ray radiation towards said item, by-passing a detection output from the second detection element while the x-ray source is directing x-ray radiation towards said item, de-activating a voltage input to the second detection element while the x-ray source is directing x-ray radiation towards said item, and filtering out second detection data which was obtained by the second detection element while the x-ray source was directing x-ray radiation towards said item. The second detection element may be configured to obtain second detection data for the item during the inactive periods for the x-ray source. The item inspection system may be configured to detect the presence of one or more articles of interest in the item based on both: (i) x-ray detection data obtained by the active detection element during the active periods, and (ii) second detection data obtained by the second detection element during the inactive periods.

The synchronisation interface may be configured to repeatedly receive universal clocking signals according to a temporally repeating pattern. The timing schedule for the operation of the x-ray source may be selected based on the frequency at which universal clocking signals are received. A frequency of pulses of x-ray radiation emitted by the x-ray source may be an integer multiple of the frequency at which the universal clocking signals are received. The wireless module may be configured to repeatedly receive clocking signals. A new reference time may be associated with each independent clocking signal. The wireless module may be configured to receive clocking signals at a frequency of 1 Hz. The timing schedule may be selected based on the reference time associated with the most recently received clocking signal. The wireless module may be configured to repeatedly receive clocking signals according to a temporally repeating pattern. The timing schedule may be selected to provide a fixed phase offset between: (i) the temporally repeating pattern by which clocking signals are received, and (ii) the temporally repeating pattern for the sequence of operation timings which define the series of active and inactive time periods. The timing schedule may be selected so that more than one active period occurs between each subsequent clocking signal being received.

The control assembly may be configured to control operation of the x-ray source to synchronise the time periods when the x-ray source directs x-ray radiation towards said item with the reference time. The inspection system may be configured to: (i) operate the active detection element to detect x-ray radiation from the x-ray source during the active periods, and (ii) operate the passive detection element to detect other forms of radiation coming from said item during the inactive periods. The inspection system may be configured to detect the presence of one or more articles of interest in said item based on both: (i) active detection data obtained from the active detection element during an active time period, and (ii) passive detection data obtained from the passive detection element during an inactive time period. The synchronisation interface may be configured to wirelessly receive and/or transmit universal clocking signals. The synchronisation interface may include a wireless module configured to wirelessly receive a clocking signal having a reference time associated therewith. The control assembly may be coupled to the wireless module to obtain an indication of the reference time therefrom. The control assembly may be configured to control operation of the x-ray source to selectively direct x-ray radiation towards said item according to a timing schedule selected based on the reference time associated with the clocking signal. The frequency of radiation pulses from the x-ray source may be 1 Hz or more. For example, the frequency of radiation pulses may be include between 1 Hz and 1 kHz, such as between 200 Hz and 1 kHz.

The item inspection system may further include a peripheral device. The control assembly may be configured to control operation of the peripheral device based on the reference time. The peripheral device may include a dosimeter or any other device which may be selectively controlled to operate or to not operate during periods where radiation is being applied, e.g. any other component which may be used to monitor radiation levels or take other measurements which may be interfered with by radiation. The item inspection system may include a mobile inspection system. For example, the mobile inspection system may include a self-contained system, e.g. which may be moved to different locations. For example, it may include a system without wires/cables etc. which constrain the system to any one location.

In an aspect, there is provided a cargo inspection system configured to identify one or more articles of interest in an item of cargo. The cargo inspection system includes an item inspection system as disclosed herein. Said item inspection system is configured to detect the presence of one or more articles of interest in a said item of cargo. The cargo inspection system may include a mobile inspection system.

In an aspect, there is provided an article detection system including: a first item inspection system, as disclosed herein, and a second item inspection system, as disclosed herein. Each item inspection system is configured to receive the same universal clocking signal and to obtain an indication of the same reference time based on the universal clocking signal. Each item inspection system is configured to control operation of its respective x-ray source according to a timing schedule selected based on the same reference time.

In an aspect, there is provided an x-ray detection system including: an x-ray source configured to selectively direct x-ray radiation towards an item; a detection element arranged to detect x-ray radiation from the x-ray source; a GPS module configured to receive GPS signals, wherein each GPS signal provides a reference time; and a control logic module configured to control operation of the x-ray source to selectively direct x-ray radiation towards said item according to a timing schedule selected based on a reference time associated with a received GPS signal. For example, each GPS signal may provide reference time for the same common clock.

In an aspect, there is provided a method of detecting the presence of one or more articles of interest in an item, the method including: obtaining an indication of a reference time based on a universal clocking signal; controlling operation of an x-ray source to selectively direct x-ray radiation towards a said item according to a timing schedule selected based on the reference time; and controlling operation of a detection system to detect x-ray radiation from the x-ray source after irradiation of the item.

In an aspect, there is provided a method of controlling operation of an item inspection system for detecting the presence of one or more articles of interest in an item, the item inspection system including: (i) an x-ray source configured to selectively direct x-ray radiation towards a said item, and (ii) a detection system arranged to detect x-ray radiation from the x-ray source after irradiation of the item, the method including: obtaining a reference time based on a universal clocking signal; and outputting a control signal to control operation of the x-ray source to selectively direct x-ray radiation towards said item according to a timing schedule selected based on the reference time.

In an aspect, there is provided a method of operating an x-ray detection system to detect the presence of one or more articles of interest in an item, the x-ray detection system including: an x-ray source configured to selectively direct x-ray radiation towards a said item, and a detection element arranged to detect x-ray radiation from the x-ray source after irradiation of the item, wherein the method includes: receiving one or more GPS signals, wherein each GPS signal provides a reference time; and controlling operation of the x-ray source to selectively direct x-ray radiation towards said item according to a timing schedule selected based on a reference time associated with a received GPS signal.

In an aspect, there is provided a controller configured to control operation of an item inspection system for detecting the presence of one or more articles of interest in an item, the item inspection system including: (i) an x-ray source configured to selectively direct x-ray radiation towards a said item, and (ii) a detection system arranged to detect x-ray radiation from the x-ray source after irradiation of the item, wherein the controller includes: a synchronisation interface configured to obtain an indication of a reference time based on a universal clocking signal; and a control assembly configured to output a control signal to control operation of the x-ray source to selectively direct x-ray radiation towards said item according to a timing schedule selected based on the reference time.

Methods of the present disclosure may further include controlling operation of a second (e.g. passive) detection element. Operation of the second detection element may be controlled according to a second timing schedule selected based on the reference time. For example, the second (passive) detection element may be controlled to obtain second detection while the x-ray source is inactive (e.g. the second timing schedule may be temporally interleaved with the first timing schedule). The second detection element may be arranged to detect other forms of radiation, such as gamma radiation and/or neutrons.

Aspects of the present disclosure include one or more computer program products including computer program instructions configured to program a controller to perform any of the methods disclosed herein.

### FIGURES

Some examples of the present disclosure will now be described, by way of example only, with reference to the figures, in which:

FIG. 1 is a schematic diagram illustrating an exemplary item inspection system.

FIG. 2 is a timing diagram of an exemplary method of controlling operation of an item inspection system.

FIG. 3 is a functional block diagram of an exemplary item inspection system.

In the drawings like reference numerals are used to indicate like elements.

### SPECIFIC DESCRIPTION

The present disclosure relates to an item inspection system for detecting the presence of articles of interest in an item. To inspect the item, X-ray radiation is directed towards the item from an X-ray source, and X-rays which have irradiated the item are detected by an active detection element. The X-ray source is controlled to only direct x-ray radiation towards the item during selected time windows. For this, a universal clocking signal is used. The selected time windows have a fixed temporal relationship to the universal clocking signal. The item inspection may therefore receive a universal clocking signal and then control operation of the x-ray source to ensure that it emits radiation according to a timing pattern selected based on the time contained in the universal clocking signal. The universal clocking signal may be received by multiple different item inspections, and all of these may be controlled to operate according to the same timing pattern relative to the universal clocking signal. That way, x-ray radiation from one inspection system may not impede detection from another adjacent inspection system. Each item inspection system may also include a passive detection element which is also operated in a fixed temporal relationship to the universal clocking signal. The passive detection element may be operated according to a different timing pattern to the x-ray source so that the passive detection element is only obtaining measurements when the x-ray source is inactive.

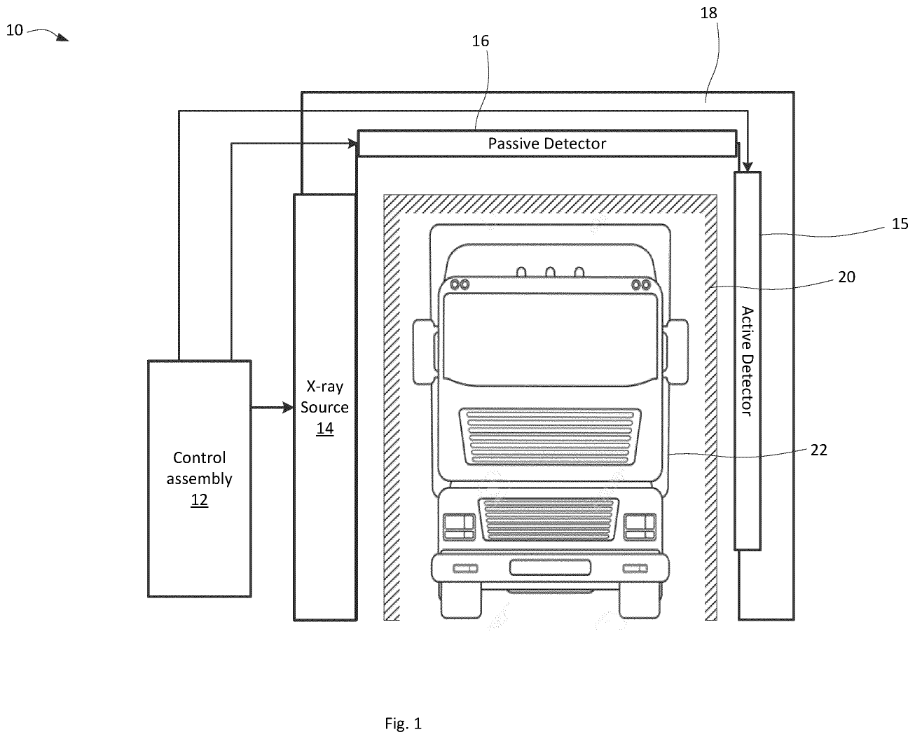

An exemplary item inspection system will now be described with reference to FIG. 1.

FIG. 1 shows an item inspection system 10. The item inspection system 10 includes a detection system and a control assembly 12. The detection system includes an x-ray source 14 and an active detector 15. The detection system may also include a passive detector 16. Also shown in FIG. 1 is a gantry 18, a scanning region 20, and an item 22 to be scanned (shown as a lorry).

In FIG. 1, the passive detector 16 and the active detector 15 are shown in different regions (the passive detector 16 is shown above the item 22, and the active detector 15 is shown to the side of the item 22). However, this arrangement should not be considered limiting, it is only used to clearly illustrate the two different detectors being present.

The x-ray source 14 and active detector 15 are arranged to enable the active detector 15 to detect x-ray radiation emitted from the x-ray source 14. The x-ray source 14 is arranged to illuminate the scanning region 20 with x-rays, and the active detector 15 is arranged to detect those x-rays. For example, the active detector 15 may be arranged to detect x-rays which have passed directly through the item 22 and/or it may be arranged to detect x-rays which have scattered off the item 22. It will be appreciated in the context of the present disclosure that the active detector 15 may be provided in any suitable location for detecting x-ray radiation associated with the x-ray source 14 which has been directed towards the item 22 to be scanned. For example, and as shown in FIG. 1, the active detector 15 may be arranged on the opposite side of the item 22 to the x-ray source 14. The scanning region 20 is defined by the volume which is illuminated by the x-ray source 14, and which is also encompassed by a field of view of the active detector 15.

The passive detector 16 is arranged to passively detect radiation from the item 22. That is, the passive detector 16 does not require illumination of the item 22 with x-rays for detection. For example, the passive detector 16 may include a gamma ray detector and/or a neutron detector. In other words, the passive detector 16 may be arranged to detect emissions coming from within the item 22 itself.

Also shown in FIG. 1 is the gantry 18. Any or all of the x-ray source 14, the active detector 15 and the passive detector 16 may be coupled to the gantry 18. For example, the detectors may be supported by the gantry 18 to enable them to detect radiation associated with an item 22 which is located within the gantry 18. The gantry 18 is large enough that an item 22 to be scanned, such as a car, a pallet, a cargo container and/or the cabin of a cargo vehicle may be disposed in the scanning region 20 (e.g. between the x-ray source 14 and the active detector 15). For example, the gantry 18 may be arranged so that such a vehicle may be driven through the scanning region 20 carrying a cargo container.

Such item inspection systems may typically be used at a facility such as a border or customs facility. In which case, there may be a number of such item inspection systems provided in close proximity to one another, and/or there may be alternative detection systems being used at the same facility. In such cases, radiation being emitted as part of the detection process at one item inspection system (e.g. x-ray radiation being emitted from the x-ray source 14) may interfere with measurements being taken at another item inspection system. For example, where there are two item inspection systems of the type shown in FIG. 1 in close proximity to each other, x-rays emitted from the x-ray source 14 of the first item inspection system may compromise the detection ability of the passive detector 16 of the second item inspection system (e.g. the passive detector 16 may detect incident x-rays, but infer that to be due to gamma rays or neutrons). Likewise, x-rays emitted from the x-ray source 14 of the first item inspection system may compromise the detection ability of the passive detector 16 of the first item inspection system. Embodiments of the present disclosure may provide control systems and methods to avoid such situations from occurring.

The control assembly 12 is configured to control operation of the x-ray source 14, the active detector 15 and/or the passive detector 16. The control assembly 12 is configured to control operation of the components of the item inspection system 10 based on an independent clocking signal. The independent clocking signal is universal. The independent clocking signal contains timing information in the form of a reference time. The same clocking signal containing the same timing information (i.e. the same reference time) may be received elsewhere (e.g. at other item inspection systems). This may enable multiple different components (e.g. different item inspection systems) to be controlled according to this independent universal clocking signal. As such, multiple different components may have their operation controlled according to the reference time contained within the clocking signal. For example, operation of different components may be aligned with respect to the same reference time, as provided in the universal clocking signal those components each receive. In other words, an item inspection system 10 may be controlled independently (i.e. by its own control apparatus), but the control apparatus may synchronise that controlled operation with the reference time associated with the universal clocking signal.

The control assembly 12 is configured to control operation of the x-ray source 14 to selectively direct x-ray radiation towards the item to be inspected. The control assembly 12 is configured to control operation of the x-ray source 14 based on the reference time associated with the clocking signal. For this, the control assembly 12 is configured to control the x-ray source 14 to emit x-rays, or to not emit x-rays, according to a timing schedule. The timing schedule is selected based on the reference time associated with the clocking signal. For instance, the timing schedule may be a fixed pattern of timings defining when the x-ray source 14 is active (emitting x-rays) and inactive (not emitting x-rays). These active and inactive time periods may be aligned with respect to the reference time. For example, the timing schedule may define a fixed, repeating pattern of active and inactive periods. This pattern may be aligned with the reference time, e.g. so that there is a fixed temporal offset between the reference time and the next active or inactive time period.

The x-ray source 14 may be controlled to emit pulses of x-ray radiation. That is, one pulse of x-rays may be emitted, which defines one active period. The x-ray source 14 may then not emit any x-rays, which defines one inactive period. The active and inactive periods may be the same duration of time, or they may be different. For the timing schedule, the duration of time for active and inactive periods may remain constant over time, or it could change over time. For example, the duration of each active period for the x-ray source 14 may remain constant over time, and the x-ray source 14 may be controlled so that the active periods repeat according to a selected frequency. The frequency of these active periods may be more than 1 Hz, such as more than 50 Hz, such as more than 100 Hz, such as more than 200 Hz. For example, the frequency of the active periods may be selected to be one of: 200 Hz, 400 Hz, 600 Hz, 800 Hz, and 1 kHz.

The universal clocking signal may occur repeatedly. That is, the universal clocking signal may occur according to a repeating pattern. For instance, the universal clocking signal may occur according to a selected frequency. The frequency associated with the universal clocking signal may be different to that for the active periods. The frequency associated with the universal clocking signal may be lower than that associated with the active periods. For example, the universal clocking signal may have a repeating frequency of 1 Hz. The control assembly 12 may be configured to control operation of the x-ray source 14 so that the repeating pattern for the active periods is aligned with the repeating pattern for the universal clocking signal. For example, there may be a fixed temporal offset between the time of the universal clocking signal and the time of the next active period commencing.

As one example for the universal clocking signal, a Global Positioning System (‘GPS’) signal may be used. However, GPS is not to be considered limiting. Other examples for the universal clocking signal are described below.

The control assembly 12 may include a GPS signal receiving unit. The GPS signal receiving unit is configured to receive GPS signals, which will typically be received at a set temporal frequency. For example, GPS signals may be received at 1 Hz (e.g. a GPS signal is received per second). As will be appreciated, GPS signals may be received from multiple different satellites at the same time. By receiving one or more GPS signals at the GPS signal receiving unit, the control assembly 12 may be configured to identify a reference time associated with the GPS signal. For example, a time of day at which the GPS signal was received may be determined by the control assembly 12. The control assembly 12 is configured to control operation of the x-ray source 14 so that the active and inactive time periods are aligned with the time of day associated with the GPS signal. For instance, operation may be controlled so that there is a fixed phase offset (e.g. a fixed difference in time) between the repeating pattern of the GPS signals being received and the repeating pattern of the active and inactive periods for the x-ray source 14. The fixed temporal offset may be monitored and controlled continuously. For example, the operational timings for the x-ray source 14 may be checked (and updated, if needed) based on the most recently received clocking signal. In other words, the active periods (when x-rays are emitted) are synchronised with reference to the reference time associated with the clocking signal.

This approach enables each different item inspection systems to control operation of its x-ray source 14 in the same way. Each item inspection system 10 may follow the same repeating pattern for active and inactive periods, with the same fixed temporal offset between that repeating pattern and the repeating pattern for which independent clocking signals are received. As the same independent clocking signal may be received at each item inspection system, the active periods for each x-ray source 14 of each item inspection system may be aligned. This may provide alignment of active and inactive periods between x-ray sources of different item inspection systems. In so doing, there may be time periods where all of the item inspection systems are on an inactive period. During these time periods, the passive detectors may be much less likely to be influenced by detection of x-rays which have been emitted by relevant x-ray sources. Likewise, alternative detection elements may also be much less likely to be influence by such x-rays during these time periods.

In addition to controlling the emission of x-rays according to active and inactive periods, the control assembly 12 may also control operation of the passive detector 16 according to the same active and inactive periods. The item inspection system 10 may be configured to emit x-rays for detection by the active detector 15 during the active periods, and to operate the passive detection element to detect other forms of radiation coming from said item 22 during the inactive periods. It is to be appreciated in the context of the present disclosure that passive detectors for detecting neutrons/gamma rays being emitted from the item 22 to be inspected may register erroneous positive results if detecting x-ray radiation emitted from the x-ray source 14 (i.e. a passive detector 16 may detect incident x-rays which are subsequently inferred as being incident gamma rays or neutrons etc.).

The control assembly 12 may be configured to provide blanking of the passive detector 16 during the active periods. Blanking of the passive detector 16 may include controlling its operation so that no measurements are used for the passive detector 16 which were taken during active periods. Passive detection using the passive detector 16 may then only occur during inactive periods (i.e. during periods when no x-rays are being emitted by the x-ray source 14). The control assembly 12 may be configured to provide this blanking in a number of different ways. Blanking may be provided by controlling operation of the passive detector 16 itself, or it may be provided by controlling the processing of detection signals obtained from the passive detector 16.

The control assembly 12 may control operation to provide blanking at the detector side in a number of different ways. The passive detector 16 may be operated by applying some form of input (e.g. an electrical signal having a selected voltage or current) to the passive detector 16, and as a result of this input signal, an output signal may be provided which indicates whether any passive detection has occurred. Signal processing circuitry may process this output signal, such as with an analogue to digital converter, to identify the presence of any passive radiation detection. For example, a gamma ray detector may output a current indicative of any incident gamma rays, and this output current may be converted into a digital signal which provides information about incident gamma ray detection. To provide blanking at the passive detector 16, the control assembly 12 may avoid providing an input signal to the passive detector 16. For example, no voltage/current input will be provided to the passive detector 16. As another example, the output signal from the passive detector 16 may be de-activated or bypassed, e.g. the passive detector 16 may be disconnected from the signal processing circuitry so that no signal processing is done on the output signal (e.g. the output signal could be grounded).

Additionally, or alternatively, blanking could be provided through the signal processing. The signal processing circuitry may operate to generate a digital measurement signal from analogue signal measurements. This digital measurement signal could be filtered so that measurements occurring during active periods are removed from the signal. As another example, the signal processing circuitry may be controlled to be inactive during the active periods (e.g. so that it is not producing a digital output signal during the active periods).

As described above, the item inspection system 10 may be configured to obtain x-ray item inspection data during the active periods by directing x-ray radiation towards the item 22 and using the active detector 15 to detect corresponding x-rays. The item inspection system 10 may be configured to obtain passive detection data by using the passive detector 16 to detect radiation being emitted from the item 22 during the inactive periods. Obtaining active detection data may be temporally interleaved with obtaining passive detection data (e.g. so that both are not obtained at any one moment in time). The inspection of the item 22 may be performed based on both streams of input data. For example, the presence of articles of interest in the item 22 may be determined based on either active x-ray data or passive radiation data. In the event that the item inspection is clear (e.g. no indication of the presence of any articles of interest), then the item 22 to be inspected may be passed, and this item 22 may be moved away from the item inspection system 10 for onward travel. In the event that the item inspection is not clear (e.g. there was an indication of the presence of one or more articles of interest), then the item 22 to be inspected may not be passed, and further inspection of the item 22 may occur.

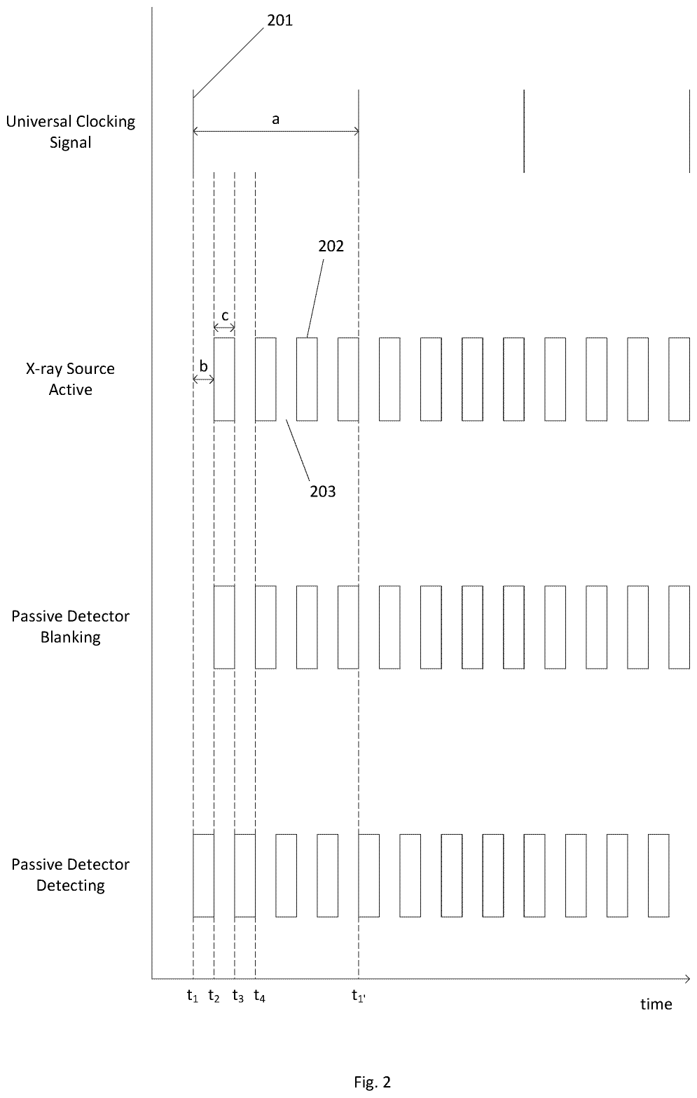

Operation of the item inspection system 10 will now be described with reference to the operational timing diagram shown in FIG. 2.

FIG. 2 shows a timing diagram for four aspects of the item inspection system 10 of FIG. 1. These are for: (i) when universal clocking signals are received, (ii) when the x-ray source 14 is active, (iii) when the passive detector 16 is blanked, and (iv) when the passive detector 16 is detecting.

In operation, the control assembly 12 receives a universal clocking signal 201 at time t¬1. The universal clocking signal is used to provide a reference time with which operation of the x-ray source 14 and passive detector 16 are controlled. With reference to the ‘x-ray source active’ row of FIG. 2, a series of active periods 202 are shown by rectangles, and a series of inactive periods 203 are shown as the gaps between adjacent rectangles. The timing schedule for these inactive periods 203 and active periods 202 is aligned with reference to the time t1 at which the universal clocking signal is received.

As shown, at time t1, an inactive period commences. The x-ray source 14 is thus not active, with no x-rays being directed towards the item 22. During this inactive period, there is no passive detector blanking-for the passive detector row, the rectangles indicate periods during which blanking is occurring, and the gaps between adjacent rectangles indicate no blanking is occurring. During this inactive period, the passive detector 16 is detecting. As such, passive radiation data may be obtained for the item 22. Operation of the passive detector 16 is shown by the rectangles, with the space between adjacent rectangles indicating that no passive detection is occurring.

While the x-ray source 14 is inactive, e.g. between t1 and t2, no passive detector blanking is provided, and the passive detector 16 is used to obtain passive detection data. This process occurs for a duration of time denoted by the reference b. Once this amount of time has passed, at t2, operation of the item inspection system 10 switches. At which point, an active period commences. While the x-ray source 14 is active, e.g. between t2 and t3, passive detector blanking occurs, and so no passive detector detecting occurs. This process occurs for a duration of time denoted by the reference c. As such, the timing schedule for active/inactive periods is aligned with the universal clocking signal reference time to provide a fixed temporal offset of b between when the clocking signal is received and when the next active period commences (i.e. the first active period after the clocking signal is received). As such, between t1 and t2, passive detection data is obtained, and between t2 and t3, active (x-ray) detection data is obtained.

These active periods 202 and inactive periods 203 repeat cyclically. As such, between t3 and t4, another inactive period occurs. The inactive period between t3 and t4 will last for the same amount of time as the previous inactive period. Likewise, a subsequent active period will last for the same amount of time as a previous active period. In the example shown in FIG. 2, the amount of time between adjacent clocking signals being received is much larger than that between active and inactive periods occurring. As such, a number of active and inactive periods occur before the next clocking signal is received. In FIG. 2, the amount of time separating adjacent clocking signals is denoted by reference a. The first clocking signal is received at t1 and the second clocking signal is received at t1′. Between these two signals being received a number of active and inactive periods will occur (four of each are shown in FIG. 2 but the number could be much higher). After t1′, the same cycle occurs as did after t1. That is, an inactive period follows for duration b and a subsequent active period follows for duration c, and this process repeats again until the next clocking signal is received.

As such, detection data is obtained which includes passive detection data and active (x-ray) detection data. The passive detection data is obtained by the passive detector 16 during inactive time periods, and the active detection data is obtained by the active detector 15 during active time periods. The active time periods are temporally interleaved with the inactive time periods. Thus, only one stream of detection data is obtained for any one moment in time. Over a longer period of time, both forms of detection data are obtained, and may be used to identify the presence of one or more articles of interest in the item 22.

As will be appreciated in the context of the present disclosure, this timing diagram of FIG. 2 is not to be considered limiting, but is instead intended to illustrate basic principles of operation. For example, in FIG. 2, the active and inactive periods are perfectly aligned. However, this need not be the case. For example, the passive detector blanking may not perfectly align with the active periods for the x-ray source (e.g. there may be a small lag after x-ray detector is inactive before the passive blanking is stopped). For example, the blanking may be controlled so that each period of blanking is controlled to last for a selected blanking time period (e.g. this may be controlled locally, such as at the passive detector). This selected blanking time period may be chosen to be long enough to avoid blanking not occurring while the x-ray is active, and to give enough time for passive detection during a period when there is no active x-ray (e.g. before the next blanking time period starts).

Similarly, it will be appreciated that the x-ray source may be active and inactive during an ‘active period’. For example, one active period for the x-ray source may include application of a series of x-ray pulses towards the item. In other words, during each active period for the x-ray, a plurality of successive x-ray pulses may be delivered towards the item. The succession of x-ray pulses may stop at the end of the active period. The time gap between successive active periods may be larger (e.g. much larger) than the time between successive x-ray pulses within one active period. Each active period for the x-ray source may include a time window during which the x-ray source may be active (e.g. where the x-ray source is active for at least some of that time period), whereas each inactive period for the x-ray source may include a time window during which the x-ray source is inactive (e.g. with no active time in that window). The x-ray source may only be actively emitting pulses of x-ray radiation during a small portion of each active period, e.g. less than half of the active period.

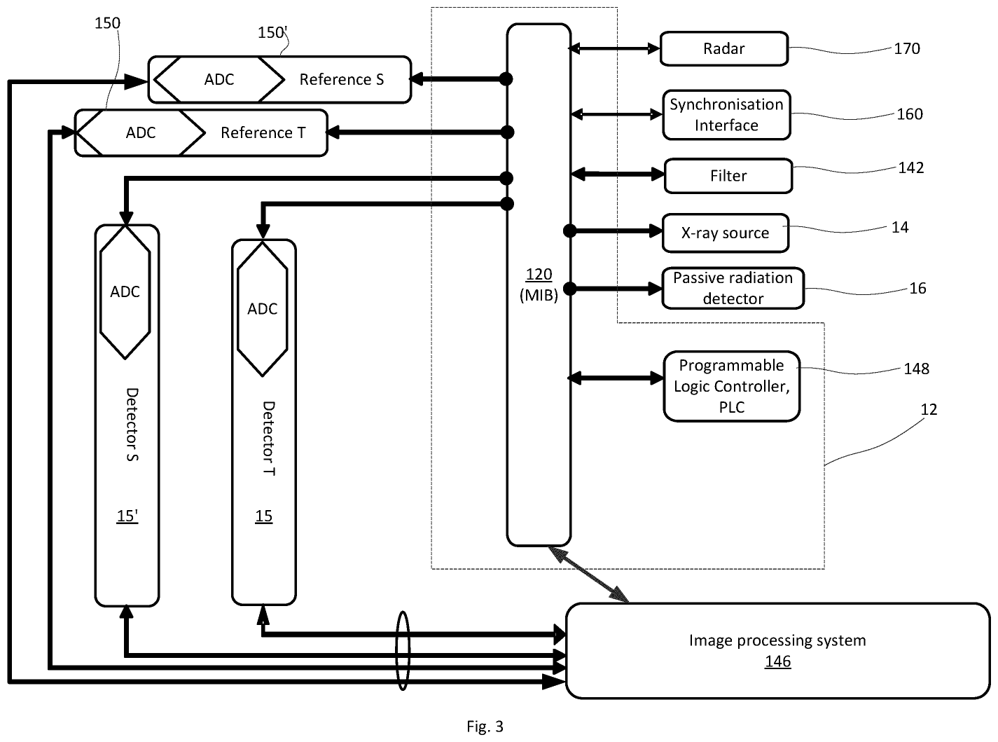

Exemplary control systems and methods for an item inspection system will now be described with reference to FIG. 3.

FIG. 3 shows a functional black diagram of the electronic architecture of an item inspection system, such as the item inspection system 10 illustrated in FIG. 1. The system includes a control logic module, sometimes called “Master Interconnection Box”, MIB, 120, an x-ray source 14 for providing x-rays, and a plurality of detector assemblies 15, 15′. The system may also include a corresponding plurality of reference detectors 150, 150′, one for each detector assembly 15, 15′. The system also includes an external synchronization interface 160 for obtaining synchronization signals from a remote device and/or for providing such a signal as an output to control other x-ray inspection systems having such functionality.

The item inspection system may also include one or more peripheral devices/components configured to provide peripheral functionality. A peripheral device may include one or more of the following (as shown in FIG. 3): a rotating filter 142, a passive radiation detector 16, a programmable logic controller, PLC 148, an image processing system, IPS 146, and/or a speed sensing radar 170.

Each of the components is coupled to the control logic module, MIB, 120. In this sense, the control logic module may form a control assembly 12 for the item inspection system although it will be appreciated that the control assembly 12 may encompass additional components, such as any of the peripheral devices (e.g. synchronisation interface 160) coupled to the control logic module 120. The control logic module 120 is connected to the reference detectors 150, 150′ and to the detector assemblies 15, 15′ by a real-time signal connection, such as a serial interface, which may operate according to a serial data protocol such as Synchronous Serial Interface (SSI) or Universal Asynchronous Receiver Transmitter (UART). The control logic module 120 is also connected to peripherals such as the rotating filter 142, the x-ray source 14, the passive radiation detector 16, the programmable logic controller 148, the synchronisation interface 160 and the radar 170. The connection between the peripherals and the control logic module 120 may also be provided by the real-time signal connection (e.g. serial interface or a triggering signal).

As described herein, the control assembly 12 may be configured to control operation of the item inspection system to be synchronised with a reference time associated with a universal clocking signal. The universal clocking signal may include a signal which is available to other devices, such as other item inspection systems, e.g. to enable those other devices to use the signal to obtain an indication of the same reference time. In other words, the universal clocking signal is a signal having a reference time associated therewith so that any device which receives that universal clocking signal may align their operational timings against that same reference time. The item inspection system may be configured to transmit and/or receive such universal clocking signals. For transmission, the item inspection system may be configured to generate the universal clocking signal itself, and transmit this universal clocking signal so that other devices may receive that universal clocking signal (and align their operational timings with it). For receiving, the item inspection system may be configured to receive the universal clocking signal from an external entity (another item inspection system, or some other signal transmission means, e.g. GPS signals). Exemplary systems with both functionalities will now be described.

For example, the control logic module 120 may include an internal clock. The internal clock may be used for providing reference timings for use in universal clocking signals. Those reference timings may be used by the item inspection system itself for aligning its operational timings with the relevant reference time. Those reference timings may also be transmitted elsewhere (e.g. broadcast to other devices) so that other devices may also align their operational timings with the relevant reference time. In other words, the control logic module 120 may include an internal clock for providing synchronisation signals (both for itself and/or for other devices). In this sense, the item inspection system may act as a master, and any other devices whose operational timings are aligned with universal clocking signal transmitted from the item inspection system may act as slaves. The synchronisation interface 160 may be used for transmitting the universal clocking signal to other devices, and/or for receiving universal clocking signals transmitted from another device. The synchronisation interface 160 may include an external synchronisation interface (e.g. for communication with external devices-for transmitting and/or receiving external, universal signals).

The control logic module 120 may include a real time data communication interface, for real time input/output communications via the real time signal connections. It may also include timing and logic circuits for processing instructions and providing, via the serial i/o interface, control signals to: (i) trigger operation of the detector assemblies 15, 15′ (e.g. to cause the capture of signals, and/or the digitisation of data based on said signals), and/or (ii) trigger operation of the x-ray source 14 e.g. to deliver a dose of x-ray radiation to the scanning volume. For example, the control logic module 120 may be configured to control operation of the x-ray source 14 to deliver pulses of x-ray radiation towards the item 22 according to a timing schedule based on the reference time associated with the universal clocking signal (e.g. as obtained using one of the external synchronisation interface and/or the internal clock).

The control logic module 120 may also be operable to control the x-ray source 14, and to synchronise operation of the detector assemblies 15, 15′ and the reference detectors 150, 150′ with operation of the x-ray source 14. This synchronising operation may be performed with reference to the reference time associated with the universal clocking signal. In addition to synchronising operation of the x-ray source 14 with the reference time, the control logic module 120 may also synchronise operational timings for one or more of the peripheral devices. For example, the control logic module 120 may be configured to synchronise operational timings for the passive detector 16. This may include providing blanking of the passive detector 16 during active periods when the x-ray source 14 is emitting x-rays.

A programmable logic controller, PLC, 148 may also be provided. This may be included in the control logic module 120, or may be provided as a separate circuit, such as a separate chip. This may include logic for providing control signals and for programming of the control logic module 120. This can enable low-level program instructions to be provided to the control logic module 120.

The control logic module 120 may be separate from the detector elements of the detector assemblies 15, 15′. The control logic module 120 may be configured to control operation of both (a) the detector elements of the detector assemblies 15, 15′ and (b) the x-ray source 14. It may also be configured to synchronize acquisition of x-ray inspection data from the detector elements of the detector assemblies 15, 15′ and the reference detectors 150, 150′ with operation of the x-ray source 14.

The detector assemblies (detector S, and detector T) 15, 15′ include x-ray sensing elements, configured to provide electrical signals in response to x-ray radiation incident on the detectors 15, 15′. The detector assemblies 15, 15′ also include an analogue front end, which couples the electrical signals from the sensing elements to an analogue-to-digital converter (ADC). The detector assemblies may also include a detector line control unit (also referred to herein as a Concentrator Board ‘COB’). The detector line control unit may be configured to obtain a synchronisation signal from the control logic module 120 and to synchronise operation of the ADC with the synchronisation signal from the control logic module 120. The ADC thus provides raw data, digitised from the electrical signals from the sensing elements, to the COB. The COB encodes the raw-data for transmission over a serial data link, such as ethernet. For example, the COB may encode the data into frames and/or packets for transmission via a packet switched or label switched protocol such as User Datagram Protocol (UDP) based data transfer or Transmission Control Protocol (TCP). Data can thus be provided from the detector assemblies to the IPS for image reconstruction and analysis.

Unlike the detector assemblies 15, 15′ the reference detectors (Reference S, Reference T) are disposed on the same side of the scanning region 20 as the x-ray source 14 and positioned for detecting the illumination provided by the x-ray source 14 but which has not passed through the imaging region. The reference detectors (Reference S, Reference T) 15, 15′ may include components which are similar (e.g. or even identical) to components of the detector assemblies (Detector S, and Detector T). The reference detectors 15, 15′ may thus be configured to provide a reference detection signal for use in signal normalisation and image reconstruction by the image processing system, IPS, 146. When data is captured by the detector elements of the detector assemblies 15, 15′ corresponding data may also be captured by the reference detectors 150, 150′ and provided to the image processing system 146. The acquisition of such data may be synchronised under control of the control logic module 120 to enable the data from the detector elements of the detector assemblies 15, 15′ to be normalised e.g. to account for variability in source power or other variations.

It can thus be seen that the detector elements of the detector assemblies (Detector S, and Detector T) 15, 15′ and the reference detectors 150, 150′ combine analogue front-end components, and an A/D converter connected directly with the sensing elements of the detector assemblies. The output current signals generated by each sensing element (e.g. each pixel) are collected and digitalized simultaneously by the ADC so they can be provided (e.g.) by the COB to the image processing system, IPS 146.

The x-ray source 14 may include an accelerator, such as a linear accelerator, which has a control input connected to receive a trigger signal from the control logic module 120 for causing the x-ray source 14 to emit a pulse (e.g. a dose) of x-ray radiation. The trigger signals may be timed according to the timing schedule selected based on the reference time.

The detector elements of the detector assemblies and the reference detectors and the control logic module 120 may all be connected to an image processing system, IPS, 146 by a data link, such as a local area communication interface, for example an ethernet link. The detector assemblies 15, 15′ can thus provide digitised data to the image processing system 146, or to another remote device connected to this data link.

The image processing system, IPS, 146 generally includes a computer apparatus which may have a display and a user interface. The IPS 146 may be configured to receive digitised data from the reference detectors and from the detector assemblies (detector S, detector T). It may be configured to reconstruct x-ray images based on this digitised data, or to relay the data to a remote device for image reconstruction and/or inspection. The image processing system 146 is also connected to the control logic module 120 for: (i) obtaining imaging parameter data and/or (ii) providing control signals to the control logic module 120 to control imaging of an object in the scanning region 20.

As mentioned above, the item inspection system may include a variety of different peripherals. One peripheral which may be included is a rotating filter, 142 which may be mechanically coupled to the x-ray source 14 and disposed between the x-ray source 14 and the scanning region 20. The filter 142 may be arranged to be controlled by the control logic module 120. For example, operation of the filter may be controlled according to a timing schedule selected based on the reference time. The filter 142 may include a set of x-ray attenuators, each configured to provide a different degree of attenuation of radiation from the x-ray source 14. The control logic module 120 is operable to control the filter 142 to provide a selected degree of attenuation of the x-ray radiation before the x-ray radiation reaches the scanning volume to interact with an object to be scanned.

Another peripheral which may be included is another detector. In the example of FIG. 3, this additional detector is in the form of a passive radiation detector 16. This may include sensing elements configured to characterise neutrons and/or gamma-rays directly emitted from nuclear materials and radioactive sources, one example of such a detector includes a detector including a scintillation material, the signal of the detector being read out by a photo-multiplier tube (or equivalent: silicon photomultiplier). However, it is to be appreciated that other forms of detector may be provided.

Another peripheral to be used may be the speed sensing radar 170. The radar 170 may be configured to sense the speed at which an item 22 to be inspected, such as a vehicle (or cargo being carried by the vehicle), is travelling. The control logic module 120 may obtain signals from the speed radar 170 indicating the speed of the object, and may control operation of the x-ray source 14 and the detector elements of the detector assemblies based on these speed signals.

As one example for operation of the item inspection system of FIG. 3, the control logic module 120 may obtain low level program instructions from the programmable logic controller, PLC, 148 and control operation of the x-ray source 14 and the detector elements of the detector assemblies 15, 15′, and the reference detectors 150, 150′ in accordance with these instructions. This includes synchronizing operation of the item inspection system according to a reference time associated with a universal clocking signal. As mentioned above, that may be a reference time and universal clocking signal generated by the item inspection system and transmitted to other devices using the external synchronisation interface 160, or it may be a reference time associated with a universal clocking signal which was received at the item inspection system via the external synchronisation interface 160.

The control logic module 120 may synchronise operation of the ADCs of the detector elements of the detector assemblies 15, 15′, and the reference detectors 150, 150′ with pulses (doses) of x-ray radiation provided from the x-ray source 14 into the scanning volume. For each pulse, the control logic module 120 sends control signals via the serial interface, through the detector line control unit, COB, to control the ADCs to cause the ADCs to digitalize signals from the detector elements of the detector assemblies. This causes the detector line control unit, COB to concatenate and reorder the digital data. This digital data is then transferred from the detector line control unit, COB, on a high-speed data link (such as ethernet or equivalent) to the image processing system, IPS, which may provide an image work-station for image reconstruction and inspection. The IPS 146 may also relay such data to a remote device for inspection and/or storage and/or analysis.

The control logic module 120 also synchronizes operation of the peripherals with the emission of pulses. Where relevant, any changes to the filter 142 may be controlled according to a timing schedule selected based on the reference time. As another example, the passive radiation detector 16 may be controlled to obtain passive radiation detection data during periods when the x-ray source 14 is inactive. For example, the timings may be synchronised to the reference time with the x-ray source 14 active during active periods and inactive during inactive periods, with the passive detector 16 being blanked during the active periods of the x-ray source 14, but used to obtain data during the inactive periods of the x-ray source 14.

When operating as a master, the control logic module 120 may generate a universal clocking signal having a reference time associated therewith, and use this reference time when selecting a timing schedule for controlling operation of the item inspection system 120. For example, to control operation of the ADC of the detector elements of the detector assemblies 15, 15′ and/or operation of the x-ray source 14 according to that timing schedule as described above. The control logic module 120 may then also provide this universal clocking signal (e.g. a co-timed signal based on these triggers) to the external synchronization interface 160. The external synchronization interface 160 then relays this signal for communicating to another device, e.g. another item inspection system via an external synchronization interface of that other item inspection system. Communicating this signal may be wired and/or may include transmitting the signal wirelessly. If that other item inspection system is operating in slave mode, it uses the universal clocking signal to control the timing of its own x-ray source 14 and its own detectors.

When operating as a slave, the control logic module 120 may obtain a universal clocking signal from the external synchronization interface 160 and synchronise operation of the detector elements (e.g. to cause the acquisition and digitisation of sensor signals) and the x-ray source 14 based on that universal clocking signal. The universal clocking signal need not originate from another x-ray inspection system and may be provided by any external timing reference signal (such as a radio signal, e.g. a GPS signal).

In both examples, there may be global active periods in which x-ray pulses are being emitted by x-ray sources of one or more item inspection systems, as well as global inactive periods in which none of the x-ray sources of the item inspection systems are emitting x-rays. This aligning of operational timings for multiple devices may improve operation of alternative devices, such as those which may benefit from operating during a period in which there are no x-rays being emitted. For example, passive detection elements may enable more reliable results when they are not also receiving incident x-rays from other x-ray sources.

It will be appreciated that the examples described above are not intended to be limiting. In these examples, optional features have been described to illustrate exemplary additional features for the disclosure. These should not be taken to be essential.

For example, item inspection systems of the present disclosure may include a second detection device (in addition to the x-ray source 14 and detection element). In examples described above, the second detection element includes a passive radiation detector. However, it is to be appreciated that this is just one example. Other devices (e.g. peripheral devices) could be used. The present disclosure may provide certainty and control to operational timings for when x-rays are being emitted by the x-ray source 14. A number of peripheral devices may benefit from operating while avoiding these active periods (e.g. during the inactive periods). This extends to other devices not part of the item inspection system itself. For example, the provision of a timing schedule selected based on a reference time associated with a universal clocking signal may enable external devices in the vicinity of the x-ray source 14 to operate at times when that x-ray source 14 will be inactive. Thus, technical benefits may still be provided without any second detection device present (e.g. when just using x-ray source 14 and detector).

Examples described herein have included a synchronisation interface for communication with external devices, such as to transmit universal clocking signals to other devices (when acting as master), or to receive universal clocking signals from another entity (when acting as slave). It is to be appreciated in the context of the present disclosure that the precise nature or form of these universal clocking signals should not be considered limiting. As one example, GPS signals may be used. As such, each item inspection system may include a synchronisation interface configured to receive GPS signals. The reference time may then be based on the received GPS signal. In this sense, each item inspection system of the present disclosure would be operating in a slave mode (with the universal clocking signal originating from one or more satellites). For example, the reference time may be determined based on timing signals contained in the GPS signals (and then operation controlled so that there is a fixed offset between the operational timings—such as active periods—and the reference time).

However, the use of GPS is just one example, and should not be considered limiting. The universal clocking signal may be carried by any suitable signal arranged to be transmitted and/or received. For example, the universal clocking signal may be a wireless signal arranged to be transmitted and/or received wirelessly. The synchronisation interface may include a wireless interface for transmitting and/or receiving such wireless signals. However, non-wireless signals may be used. For example, each device in a region (e.g. item inspection systems and other devices in a local area—such as an inspection area in which inspection of items is being performed) may be coupled to each other via one or more wires so that they may each receive the same universal clocking signals.

As an alternative to use of GPS signals, other types of universal clocking signal may be used. For example, any suitable electromagnetic transmission may be used. For example, use of a universal clocking signal may include use of inter-range instrumentation group timecodes (‘IRIG timecodes’). Another example of this could be light signals, such as laser light signals. Such optical signals may be modulated in such a way as to convey information pertaining to the reference time. As another example, non-GPS based radio waves could be used. These could include other satellite-based positioning systems, such as Galileo, GLONASS, NavIC etc. Other radio waves could be used, such as for local transmission between devices within a smaller geographical region (e.g. within one inspection system at a port/border/customs facility).

The universal clocking signal may be a signal which repeats cyclically. For this, the universal clocking signal may be repeatedly transmitted and/or received according to a selected frequency. For example, for GPS, a frequency of 1 Hz may apply. However, the exact frequency should not be considered limiting. Likewise, pulses of x-rays may be emitted according to a selected frequency. For example, the x-ray source 14 may switch between active periods (x-rays emitted) and inactive periods (no x-rays emitted). This switching of the x-ray source 14 may occur at a selected frequency. The switching of the x-ray mode may occur at a frequency which is higher than the frequency at which universal clocking signals are received/transmitted. In other words, between adjacent universal clocking signals, there may be a plurality of active and inactive periods. The ratio of the two frequencies may be selected so that there are an integer number of active and inactive periods occurring between adjacent universal clocking signals—that integer number may be the same for both active and inactive periods. As such, the pattern of active/inactive periods will appear the same between any two adjacent universal clocking signals.

Item inspection systems of the present disclosure may be configured to select the frequency at which the active/inactive periods occur so that different x-ray sources may use different frequencies (of active/inactive periods) but that there are still overlaps for the inactive periods. For example, the frequency of active/inactive periods may be selected to be an integer multiple (e.g. a multiple of two or more) of the frequency of universal clocking signals. As such, even if two adjacent item inspection systems are at different active/inactive frequencies, there will still be global inactive periods when no x-rays are emitted (e.g. which are suitable for alternative detection means), and the timings for these global inactive periods may be known based on a comparison of the two different frequencies being used. The control assembly 12 may be configured to control operation of the passive detection element according to the global inactive periods (e.g. so that it is blanked in global active periods—when at least one x-ray is active—but not for global inactive periods—when no x-rays are active). For example, the frequency of active/inactive regions may be any of: 200 Hz, 400 Hz, 600 Hz, 800 Hz and 1 kHz.

In the examples described above, there are different arrangements for the different detectors (e.g. active on side, passive on top). However, it will be appreciated that this should not be considered limiting. Any arrangement of detectors may be provided to enable inspection of the relevant item. For example, such an arrangement may be provided when the item is provided in the scanning region 20 so that information about the contents of the item may be determined based on properties of x-rays passing from source to detector via the item. Any passive detection elements may be provided in a suitable location to register an indication of any radiation being emitted from the item.

It will be appreciated from the discussion above that the examples shown in the figures are merely exemplary, and include features which may be generalised, removed or replaced as described herein and as set out in the claims. With reference to the drawings in general, it will be appreciated that schematic functional block diagrams are used to indicate functionality of systems and apparatus described herein. In addition, the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some examples the function of one or more elements shown in the drawings may be integrated into a single functional unit.

As will be appreciated by the skilled reader in the context of the present disclosure, each of the examples described herein may be implemented in a variety of different ways. Any feature of any aspects of the disclosure may be combined with any of the other aspects of the disclosure. For example, method aspects may be combined with apparatus aspects, and features described with reference to the operation of particular elements of apparatus may be provided in methods which do not use those particular types of apparatus. In addition, each of the features of each of the examples is intended to be separable from the features which it is described in combination with, unless it is expressly stated that some other feature is essential to its operation. Each of these separable features may of course be combined with any of the other features of the examples in which it is described, or with any of the other features or combination of features of any of the other examples described herein. Furthermore, equivalents and modifications not described above may also be employed without departing from the invention.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates.

Other examples and variations of the disclosure will be apparent to the skilled addressee in the context of the present disclosure.

1. An item inspection system for detecting the presence of one or more articles of interest in an item, the item inspection system comprising:
an x-ray source configured to selectively direct x-ray radiation towards said item;
a detection system comprising an active detection element arranged to detect x-ray radiation from the x-ray source after irradiation of the item; and
a control assembly configured to control operation of the x-ray source to selectively direct x-ray radiation towards the item according to a timing schedule;
wherein the control assembly comprises a synchronisation interface configured to obtain an indication of a reference time based on a universal clocking signal; and
wherein the control assembly is configured to select the timing schedule based on the reference time.

2. The item inspection system of claim 1, wherein the timing schedule specifies a sequence of operation timings to define a series of active and inactive periods for the x-ray source, and wherein the x-ray source is controlled to direct x-ray radiation towards said item during the active periods, but not during the inactive periods.

3. The item inspection system of claim 2, wherein the control assembly is configured to synchronise the operation timings for active and/or inactive periods with respect to the reference time obtained by the synchronisation interface.

4. The item inspection system of claim 2, wherein the timing schedule aligns the operation timings for the active and inactive periods with the reference time so that the sequence of operation timings has a fixed temporal offset relative to the reference time.

5. The item inspection system of claim 2, wherein the sequence of operation timings which define the series of active and inactive time periods follows a temporally repeating pattern.

6. The item inspection system of claim 1, wherein the synchronisation interface is configured to wirelessly receive and/or transmit universal clocking signals.

7. The item inspection system of claim 6, wherein the synchronisation interface comprises a GPS module configured to wirelessly receive GPS signals, and wherein the universal clocking signal comprises a GPS signal.

8. The item inspection system of claim 1, further comprising a second detection element, wherein the control assembly is configured to control operation of the second detection element according to a second timing schedule, and wherein the second timing schedule is selected based on the reference time.

9. The item inspection system of claim 8, wherein the second timing schedule is temporally interleaved with the first timing schedule so that the second detection element is arranged to obtain second detection data for the item while the x-ray source is inactive.

10. The item inspection system of claim 8, wherein the second detection element is arranged to detect other forms of radiation coming from said item.

11. The item inspection system of claim 8, wherein the control assembly is configured to control operation of the item inspection system to provide blanking of the second detection element when the x-ray source is directing x-ray radiation towards said item.

12. The item inspection system of claim 11, wherein providing blanking of the second detection element comprises at least one of:
de-activating a detection output from the second detection element while the x-ray source is directing x-ray radiation towards said item,
by-passing a detection output from the second detection element while the x-ray source is directing x-ray radiation towards said item,
de-activating a voltage input to the second detection element while the x-ray source is directing x-ray radiation towards said item, and
filtering out second detection data which was obtained by the second detection element while the x-ray source was directing x-ray radiation towards said item.

13. The item inspection system of claim 8, wherein the timing schedule specifies a sequence of operation timings to define a series of active and inactive periods for the x-ray source, wherein the x-ray source is controlled to direct x-ray radiation towards said item during the active periods, but not during the inactive periods, and wherein the second detection element obtains second detection data for the item during the inactive periods for the x-ray source.

14. The item inspection system of claim 13, wherein the item inspection system is configured to detect the presence of one or more articles of interest in the item based on both: (i) x-ray detection data obtained by the active detection element during the active periods, and (ii) second detection data obtained by the second detection element during the inactive periods.

15. The item inspection system of claim 1, wherein the synchronisation interface is configured to repeatedly receive universal clocking signals according to a temporally repeating pattern; and
wherein the timing schedule for the operation of the x-ray source is selected based on the frequency at which universal clocking signals are received.

16. The item inspection system of claim 1, wherein the item inspection system further comprises a peripheral device; and
wherein the control assembly is configured to control operation of the peripheral device based on the reference time, optionally wherein the peripheral device comprises a dosimeter.

17. The item inspection system of claim 1, wherein the item inspection system is a mobile inspection system.

18. A cargo inspection system configured to identify one or more articles of interest in an item of cargo, wherein the cargo inspection system comprises the item inspection system of claim 1, and wherein said item inspection system is configured to detect the presence of one or more articles of interest in a said item of cargo.

19. (canceled)

20. An x-ray detection system comprising:
an x-ray source configured to selectively direct x-ray radiation towards an item;
a detection element arranged to detect x-ray radiation from the x-ray source;
a GPS module configured to receive GPS signals, wherein each GPS signal provides a reference time; and
a control logic module configured to control operation of the x-ray source to selectively direct x-ray radiation towards said item according to a timing schedule selected based on a reference time associated with a received GPS signal.

21. A method of detecting the presence of one or more articles of interest in an item, the method comprising:
obtaining an indication of a reference time based on a universal clocking signal;
controlling operation of an x-ray source to selectively direct x-ray radiation towards a said item according to a timing schedule selected based on the reference time; and
controlling operation of a detection system to detect x-ray radiation from the x-ray source after irradiation of the item.

22. (canceled)

23. (canceled)

24. (canceled)

25. (canceled)
